(19) United States
(12) Patent Application Publication
(10) Pub. No.: US 2025/0341491 A1
(43) Pub. Date: Nov. 6, 2025

(54) NANO-C ISOTOPE ANALYSIS DEVICE

(71) Applicant: University of Science and Technology of China, Hefei (CN)

(72) Inventors: Bing GONG, Hefei (CN); Xiangping ZHA, Hefei (CN)

(21) Appl. No.: 19/019,977

(22) Filed: Jan. 14, 2025

Related U.S. Application Data
(63) Continuation of application No. PCT/CN2024/131704, filed on Nov. 13, 2024.

(30) Foreign Application Priority Data
May 6, 2024 (CN) 202410546821.9

(51) Int. Cl. G01N 27/62; G01N 1/42

(52) U.S. Cl. CPC G01N 27/62; G01N 1/42

(57) ABSTRACT

A Nano-C isotope analysis device includes an element analysis system, a carbon dioxide freezing enrichment system and an isotope mass spectrometry analysis system connected in sequence. The carbon dioxide freezing enrichment system includes a six-way valve, and the six-way valve is in communication with a first freezing assembly and a second freezing assembly. and the second freezing assembly is in communication with the isotope mass spectrometry analysis system. The first freezing assembly includes a first freezing container, and a first cold trap in communication with the six-way valve is arranged and capable of being lifted and lowered in the first freezing container. The second freezing assembly includes a second freezing container, and a second cold trap in communication with the six-way valve is arranged and capable of being lifted and lowered in the second freezing container.

### CROSS-REFERENCE TO RELATED APPLICATIONS

This application is a continuation of PCT/CN2024/131704, filed Nov. 13, 2024 and claims priority of Chinese Patent Application No. 202410546821.9, filed on May 6, 2024, the entire contents of which are incorporated herein by reference.

### TECHNICAL FIELD

The present disclosure belongs to the technical field of earth and planetary chemical instruments and equipment, and in particular relates to a Nano-C isotope analysis device.

### BACKGROUND

Carbon is not only one of the rich elements on the earth, but also an important element in the composition and evolution of carbon-based life on the earth. Plate subduction provides the driving force for the circulation of carbon in the earth and on the surface (Dasgupta et al., 2004; Wang et al., 2014; Plank&Manning, 2019), this carbon cycle will have a huge impact on the earth's climate and the livability of the surface (Mason et al., 2017). Using carbon isotopes in natural geological samples may not only trace the material source in the process of carbon cycle, but also trace the specific geological processes in the process of carbon cycle (Zheng et al. 2000; Galvez et al., 2013; Wang et al., 2014; Zhao et al., 2016; Plank&Manning, 2019). Therefore, accurate determination of carbon isotope composition in natural geological samples is of great scientific significance for studying carbon in the earth and global carbon cycle.

There are various forms of carbon in natural geological samples, mainly divided into carbonate forms and non-carbonate forms. Carbonate forms include compounds composed of carbonate and bicarbonate with different cations. Non-carbonate forms are mainly elemental carbon (graphite, diamond, etc.). Using the difference of carbon isotope composition, the source of carbon may be effectively distinguished, for example, organic carbon (such as graphite, with an average δ¹³C of −25‰) and inorganic carbon (such as marine carbonate, with an average δ¹³C of 0‰) may be distinguished. The methods of carbon isotope analysis for different types of carbon are mainly divided into two categories. The acid dissolution method is mainly used for carbon isotope analysis of carbonate forms (McCrea, 1950; Brenna et al., 1997; Révész&Landwehr, 2002; Paul&Skrzypek, 2006), while combustion method is mainly used for carbon isotope analysis of non-carbonate forms (Fuex&Bake, 1973; Werner et al., 1999; Zheng et al., 2000; Skrzypek&Paul, 2006).

The advantages and disadvantages of various analysis methods for different forms of carbon in minerals are as follows.

McCrea phosphoric acid method is a classical analysis method, which belongs to acid dissolution method and is suitable for constant pure carbonate analysis. This method belongs to off-line analysis method (McCrea, 1950). This method has the advantages of high accuracy of analysis results and applicability to different types of carbonates. However, the limitation of this method is that as an off-line analysis method, it requires the use of isotope gas mass spectrometer for dual-way injection analysis, which requires a large sample amount, generally requiring a sample amount higher than 10 milligrams (mg).

The Gasbench-MS method is also an acid dissolution method, mainly using the online continuous flow analysis method of Gasbench device and isotope gas mass spectrometer connected in line (continuous flow mode, Gasbench-CF-IRMS, abbreviated as Gasbench-MS) (Brenna et al., 1997; Révész&Landwehr, 2002; Paul&Skrzypek, 2006), which is suitable for the analysis of carbonate with small sample amount. Compared with the traditional phosphoric acid method, this method has the advantages of higher accuracy of analysis results and less sample amount, and may accurately analyze the isotopic composition of micromolar carbon (Révész&Landwehr, 2002; Paul&Skrzypek, 2006; Zha et al., 2010). This method may not only analyze pure carbonates, but also trace carbonates in silicate (Zha et al., 2010, 2018). However, the limitation of this method is that it may not accurately determine samples with lower carbon content, such as nanomolar carbon.

Elemental Analyzer-Mass Spectrometer (EA-MS) method belongs to the method of combustion oxidation, which is mainly an online continuous flow analysis method of the combustion elemental analyzer and isotope gas mass spectrometer connected in line (Brenneal., 1997; Werner et al., 1999). This method was mainly applied in the early stages for the analysis of carbon isotopes in organic matter samples, and has also been used for the analysis of carbon isotope composition in natural geological samples (Zheng et al., 2000; Skrzypek&Paul, 2006; Zha et al., 2018). The advantage of this method is that it may not only analyze non-carbonate carbon (such as graphite) in geological samples, but also analyze carbonate carbon (Skrzypek&Paul, 2006; Zha et al., 2018). The isotopic composition of micromolar carbon may be accurately determined (Skrzypek&Paul, 2006; Zha et al., 2018). However, the disadvantage of this method is that it may not accurately determine the nanomolar carbon (Zha et al., 2018).

At present, there are two trends in the development of isotope geochemistry and planetary chemistry analysis technology, namely “trace” and “micro analysis”. “Trace” means that the content of the analyzed object in the sample is lower than the detection limit of the instrument, so the analyzed object may not be accurately determined. “Micro analysis” refers to the direct in-situ analysis of samples (such as ion probes, etc.). There is also a “trace” technical bottleneck for the isotope analysis of different types of carbon in natural samples. For example, the research of Zha et al. (2018) found that when analyzing the carbon isotope composition of trace carbonate in silicate by Gasbench-MS method, when the amount of carbonate is less than 30 micrograms, the accuracy and precision of the analysis results are poor. When using EA-MS method to analyze the isotopic composition of non-carbonate carbon in silicate, if the carbon content in the sample is less than 500 parts per million (ppm), even if the weighing amount is optimized, the analysis result is still very unsatisfactory.

Therefore, the present disclosure designs a Nano-C isotope analysis device to solve the above technical problems.

### SUMMARY

In order to solve the above technical problems, the present disclosure provides a Nano-C isotope analysis device, which may accurately determine the isotopic composition of different forms of carbon at nanomolar level in earth and extraterrestrial samples.

In order to achieve the above objectives, the present disclosure provides a Nano-C isotope analysis device, including an element analysis system, a carbon dioxide freezing enrichment system and an isotope mass spectrometry analysis system which are connected in sequence;
the carbon dioxide freezing enrichment system includes a six-way valve connected to the element analysis system, the six-way valve is in communication with a first freezing assembly and a second freezing assembly which are independently arranged, and one end of the second freezing assembly is in communication with the isotope mass spectrometry analysis system;
the first freezing assembly includes a first freezing container containing a freezing liquid, and a first cold trap in communication with the six-way valve is arranged and capable of being lifted and lowered in the first freezing container; and
the second freezing assembly includes a second freezing container containing a freezing liquid, and a second cold trap in communication with the six-way valve is arranged and capable of being lifted and lowered in the second freezing container.

In some embodiments, the element analysis system includes an element analyzer, a reaction tube is arranged in the element analyzer for converting carbon elements in raw materials to be detected into gaseous carbon dioxide, one port of the reaction tube is in communication with the six-way valve through a ventilation pipeline, and a first gas supply device is arranged on the ventilation pipeline for supplying high-speed carrier gas.

In some embodiments, a chemical trap is arranged on the ventilation pipeline, and the chemical trap is arranged between the element analyzer and the six-way valve, a first port of the chemical trap is in communication with the second port of the reaction tube, and a second port of the chemical trap is in communication with the six-way valve.

In some embodiments, the ventilation pipeline is provided with two branch pipes independently arranged, and the two branch pipes are respectively provided with a first valve and a second valve, the first valve is in communication with an exhausting device for evacuating carrier gas, and the second valve is in communication with a second gas supply device for supplying auxiliary carrier gas.

In some embodiments, when the first cold trap is located below a freezing liquid level in the first freezing container to freeze carbon dioxide gas for a first time, the second cold trap is separated from the second freezing container, the ventilation pipeline is in communication with a first port of the first cold trap through the six-way valve, and a second port of the first cold trap is in communication with an evacuation pipe arranged on the six-way valve through the six-way valve.

In some embodiments, when the first cold trap is located in the first freezing container to freeze the carbon dioxide gas for the first time, a first port of the second cold trap is in communication with a third gas supply device through the six-way valve, and a second port of the second cold trap is in communication with the isotope mass spectrometry analysis system.

In some embodiments, when the second cold trap is below a freezing liquid level in the second freezing container to freeze the carbon dioxide gas for a second time, the first cold trap is separated from the first freezing container to ensure carbon dioxide frozen and enriched in the first cold trap to be completely frozen and enriched in the second cold trap, and the ventilation pipeline is in communication with the evacuation pipe through the six-way valve; and the third gas supply device is in communication with the second port of the first cold trap through the six-way valve, and the first port of the first cold trap is in communication with the first port of the second cold trap through the six-way valve.

In some embodiments, when the first cold trap is separated from the first freezing container and the second cold trap is separated from the second freezing container, carbon dioxide frozen and enriched in the second cold trap is gasified, and low-speed carrier gas provided by the third gas supply device enters the isotope mass spectrometry analysis system.

In some embodiments, the isotope mass spectrometry analysis system includes a four-way valve in communication with the second port of the second cold trap, and the second cold trap is in communication with an isotope gas mass spectrometer through the four-way valve.

In some embodiments, the isotope gas mass spectrometer is in communication with the second port of the chemical trap through the four-way valve and directly connected to the element analyzer to realize constant analysis.

Compared with the prior art, the present disclosure has the following advantages and technical effects. The present disclosure provides a Nano-C isotope analysis device, which is used to solve the technical bottleneck of isotope analysis of extremely trace carbon and realize accurate determination of the isotope composition of nanomolar carbon. After the sample to be detected is put in the element analysis system, the mixed air inside is evacuated to reduce the influence of carbon elements in the air on the analysis of the detection results. Then the carbon elements in the sample to be detected are converted into detectable carbon dioxide. The generated carbon dioxide enters the carbon dioxide freezing enrichment system for complete freezing and enrichment of the carbon dioxide, improving the sensitivity of isotope mass spectrometry analysis of the carbon dioxide through the isotope mass spectrometry analysis system. The first freezing assembly and the second freezing assembly work separately to realize the secondary enrichment purification of carbon dioxide in the generated gas, thereby avoiding inaccurate analysis results caused by carbon dioxide escape, improving the analysis lower limit, and realizing the carbon isotope analysis of nanomolar level. When carbon dioxide is purified by freezing for the first time, the first freezing assembly is in working state, the first cold trap is immersed in the low-temperature freezing liquid in the first freezing container, the mixed gas containing carbon dioxide is frozen in the first cold trap, and the remaining carrier gas is discharged from the six-way valve. During the second freezing enrichment of carbon dioxide, the first cold trap is taken out from the low-temperature freezing liquid, and the second cold trap is immersed in the low-temperature freezing liquid in the second freezing container. After being heated and gasified, the carbon dioxide frozen and liquefied in the first cold trap passes through the six-way valve and enters the second cold trap by the low flow rate carrier gas, and is frozen and enriched again, thus improving the analysis sensitivity. The secondary freezing enrichment may mainly use the low flow rate carrier gas after the second freezing to improve the sensitivity of mass spectrometry analysis and realize the accurate determination of the isotopic composition in different forms of carbon at the nanomolar level in the earth and extraterrestrial samples.

The present disclosure is simple and compact in mechanism, convenient to use, capable of analyzing carbon elements in different forms, and realizing accurate determination of isotopic compositions in different forms of carbon at the nanomolar level.

### BRIEF DESCRIPTION OF THE DRAWINGS

The accompanying drawings, which constitute a part of the present disclosure, are used to provide a further understanding of the present disclosure. The illustrative embodiments of the present disclosure and their descriptions are used to explain the present disclosure, and do not constitute an improper limitation of the present disclosure. In the attached drawings:

FIG. 1 is a schematic structural diagram of a Nano-C isotope analysis device according to the present disclosure.

FIG. 2 is a schematic diagram of a state of a carbon dioxide freezing enrichment system during a first freezing separation according to the present disclosure.

FIG. 3 is a schematic diagram of a state of the carbon dioxide freezing enrichment system during a second freezing separation according to the present disclosure.

FIG. 4 is a schematic diagram of a state of a carbon dioxide discharging process of the carbon dioxide freezing enrichment system according to the present disclosure.

FIG. 5 is a calibration and linear diagram of the Nano-C isotope analysis device according to the present disclosure.

FIG. 6 is an accuracy analysis diagram of the Nano-C isotope analysis device according to the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more clear and understandable, the present disclosure will be further described in detail with the attached drawings and specific embodiments.

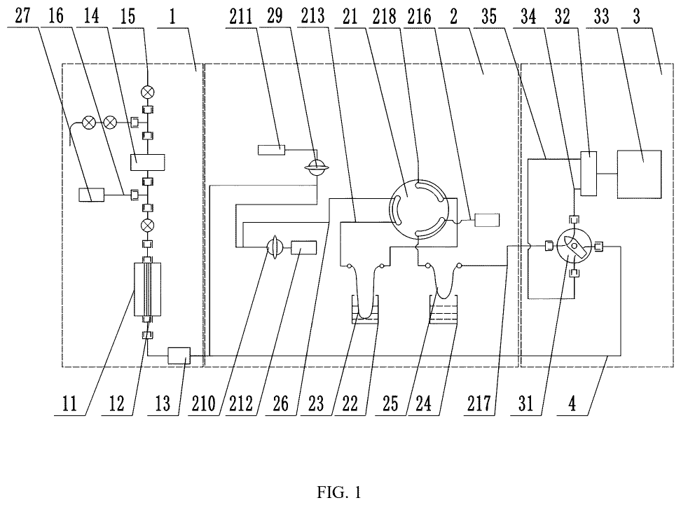

With reference to FIG. 1 to FIG. 6, the present disclosure provides a Nano-C isotope analysis device, including an element analysis system 1, a carbon dioxide freezing enrichment system 2 and an isotope mass spectrometry analysis system 3 which are connected in sequence.

The carbon dioxide freezing enrichment system 2 includes a six-way valve 21 connected to the element analysis system 1, the six-way valve 21 is in communication with a first freezing assembly and a second freezing assembly which are independently arranged, and one end of the second freezing assembly is in communication with the isotope mass spectrometry analysis system 3.

The first freezing assembly includes a first freezing container 22 containing a freezing liquid, and a first cold trap 23 in communication with the six-way valve 21 is arranged in the first freezing container 22 and capable of being lifted and lowered in the first freezing container.

The second freezing assembly includes a second freezing container 24 containing a freezing liquid, and a second cold trap 25 in communication with the six-way valve 21 is arranged in the second freezing container 24 and capable of being lifted and lowered in the second freezing container.

The present disclosure provides a Nano-C isotope analysis device, which is used to solve the technical bottleneck of isotope analysis of extremely trace carbon and realize accurate determination of the isotope composition of nanomolar carbon. After the sample to be detected is put in the element analysis system 1, the mixed air inside is evacuated to reduce the influence of carbon elements in the air on the analysis of the detection results. Then the carbon elements in the sample to be detected are converted into detectable carbon dioxide. The generated carbon dioxide enters the carbon dioxide freezing enrichment system 2 for complete freezing and enrichment of the carbon dioxide, which is convenient for isotope mass spectrometry analysis of the carbon dioxide through the isotope mass spectrometry analysis system 3. The first freezing assembly and the second freezing assembly work separately to realize the secondary freezing enrichment of carbon dioxide in the generated gas, thereby improving the analysis sensitivity. When carbon dioxide is purified by freezing for the first time, the first freezing assembly is in working state, the first cold trap 23 is immersed in the low-temperature freezing liquid in the first freezing container 22, the mixed gas containing carbon dioxide is frozen and liquefied in the first cold trap 23, and the remaining carrier gas is discharged from the six-way valve 21. During the second freezing purification of carbon dioxide, the first cold trap 23 is taken out from the low-temperature freezing liquid, and the second cold trap 25 is immersed in the low-temperature freezing liquid in the second freezing container 24. After being heated and gasified, the carbon dioxide frozen and liquefied in the first cold trap 23 passes through the six-way valve 21 and enters the second cold trap 25 by the low flow rate carrier gas, and is frozen and enriched again. At the same time, the flow rate of carrier gas may be adjusted during the secondary freezing purification, which is convenient for mass spectrometry analysis under low flow rate carrier gas in the later stage and realizes accurate determination of the isotopic composition in different forms of carbon at the nanomolar level in earth and extraterrestrial samples. The present disclosure is simple and compact in mechanism, convenient to use, capable of analyzing carbon elements in different forms, and realizing accurate determination of isotopic compositions in different forms of carbon at the nanomolar level.

In an embodiment, the low-temperature freezing liquid is liquid nitrogen, dry ice, etc. The low-temperature freezing liquid in this embodiment is liquid nitrogen, which may provide a low-temperature freezing temperature of −196° C.

In an embodiment, a chemical trap 13 is arranged on the ventilation pipeline 26, and the chemical trap 13 is arranged between the element analyzer 11 and the six-way valve 21, the first port of the chemical trap 13 is in communication with the port of a reaction tube 12, and the second port of the chemical trap 13 is in communication with the six-way valve 21. The ventilation pipeline 26 is provided with two independently arranged branch pipes 28, and the two branch pipes 28 are respectively provided with a first valve 29 and a second valve 210, the first valve 29 is in communication with an exhausting device 211 for evacuating carrier gas, and the second valve 210 is in communication with a second gas supply device 212 for supplying auxiliary carrier gas. The reaction tube 12 is arranged in the element analyzer 11, converting the carbon elements in the raw materials to be detected into carbon dioxide, and inputting the generated carbon dioxide into the six-way valve 21 through the ventilation pipeline 26. The first gas supply tube 16 is used to inject high-speed carrier gas into the device, which is convenient to drive the generated carbon dioxide gas to move. The function of the chemical trap 13 is to treat the gas generated by the reaction tube 12, remove the moisture in the mixed gas, and prevent the moisture in the subsequent low-temperature freezing purification process from affecting the subsequent separation. The first gas supply device 27 provides high-flow carrier gas for the system through the first gas supply tube 16. The second gas supply device 212 is used to provide auxiliary carrier gas, and the exhausting device 211 may be set to automatic exhaust for realizing automatic exhaust of the system.

In an embodiment, helium gas (He) is selected as the carrier gas in this embodiment, and the liquefaction temperature of helium is much lower than the freezing temperature of carbon dioxide, so helium will not liquefy during freezing purification of the carbon dioxide, thereby avoiding the influence on carbon dioxide.

In an embodiment, the flow rate of the high-speed carrier gas in this embodiment is 40-100 milliliters per minute (ml/min).

In an embodiment, the setting of the reaction duration and temperature of the sample to be treated needs to be calibrated by using the nanomolar isotope reference materials, so as to determine the appropriate reaction conditions and ensure that the carbon elements in the sample are completely converted into carbon dioxide. If the sample contains two different types of carbon, carbonate carbon and non-carbonate carbon, the optimal reaction temperature and duration of different types of carbon may be determined by using nanomolar isotope reference materials to ensure that the two different types of carbon may be converted into carbon dioxide step by step, so as to achieve the purpose of distinction.

In an embodiment, the element analysis system 1 of this embodiment further includes a vacuum sample injector 14 for placing a sample therein, and the vacuum sample injector 14 is in communication with a vacuum tube 15 for vacuumizing and the first gas supply tube 16 for introducing high-speed carrier gas.

In an embodiment, when in use, the weighed sample is put into the vacuum sample injector 14, and then the sample in the vacuum sample injector 14 is alternately vacuumized and purged with He gas, and the duration of each of vacuumizing and purging with He gas is 30 seconds, alternating 5-10 times to remove the interference of carbon in the air on the sample.

In an embodiment, the ventilation pipeline 26 is provided with two independently arranged branch pipes 28, and the two branch pipes 28 are respectively provided with a first valve 29 and a second valve 210, the first valve 29 is in communication with the exhausting device 211, and the second valve 210 is in communication with the second gas supply device 212 for supplying auxiliary carrier gas.

In an embodiment, the auxiliary carrier gas of this embodiment is also helium gas (He).

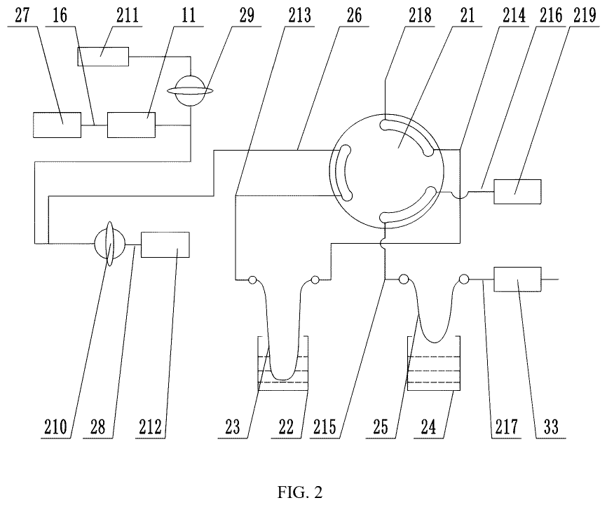

In an embodiment, when the first cold trap 23 is located in the first freezing container 22 to freeze carbon dioxide gas for the first time, the second cold trap 25 is separated from the second freezing container 24, the ventilation pipeline 26 is in communication with the first port of the first cold trap 23 through the six-way valve 21, and the second port of the first cold trap 23 is in communication with the evacuation pipe 218 arranged on the six-way valve 21 through the six-way valve 21. When the first cold trap 23 is located in the first freezing container 22 to freeze carbon dioxide gas for the first time, the first port of the second cold trap 25 is in communication with the third gas supply device 219 through the six-way valve 21, and the second port of the second cold trap 25 is in communication with the isotope mass spectrometry analysis system 3. The carbon dioxide mixed gas after water removal in the chemical trap 13 enters the six-way valve 21, and the six-way valve 21 introduces the mixed gas into the first cold trap 23 soaked in low-temperature freezing liquid through the first connecting pipe 213, and the carbon dioxide in the mixed gas is frozen by liquid nitrogen. At this time, the outlet of the first cold trap 23 is in communication with the evacuation pipe 218 through the second connecting pipe 214 and the six-way valve 21 to ensure the circulation of carrier gas, as shown in FIG. 2.

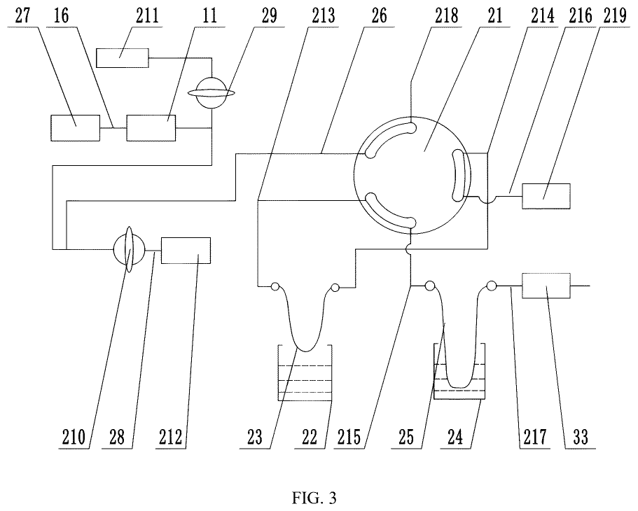

In an embodiment, as shown in FIG. 3, when the second cold trap 25 is in the second freezing container 24 to freeze carbon dioxide gas for the second time, the first cold trap 23 is separated from the first freezing container 22, and the ventilation pipeline 26 is in communication with the evacuation pipe 218 after passing through the six-way valve 21. The third gas supply device 219 is in communication with the second port of the first cold trap 23 through the six-way valve 21, and the first port of the first cold trap 23 is in communication with the first port of the second cold trap 25 through the six-way valve 21. When carbon dioxide is frozen for the second time, the first cold trap 23 is taken out of the low-temperature freezing liquid and the second cold trap 25 is immersed in the low-temperature freezing liquid. At the same time, the communication relationship of the six-way valve 21 is rotated, so that the carrier gas is directly discharged through the ventilation pipeline 26 and the evacuation pipe 218, and the third gas supply device 219 is connected to the six-way valve 21 through the fourth connecting pipe 216 to provide low-speed carrier gas. After passing through the six-way valve 21, the low-speed carrier gas enters the second port of the first cold trap 23 through the second connecting pipe 214, driving the re-gasified carbon dioxide in the first cold trap 23 to enter the six-way valve 21 through the first connecting pipe 213, and then flow into the second cold trap 25 through the third connecting pipe 215, so as to freeze and enrich the mixed gas at low temperature again. The gasified carbon dioxide driven by the low-speed carrier gas completely enters the second cold trap 25 for freezing enrichment.

In an embodiment, the flow rate of the low-speed carrier gas in this embodiment is 2-10 ml/min.

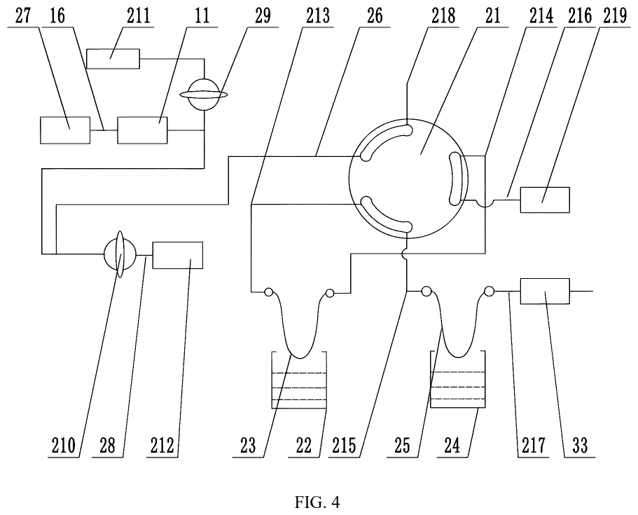

In an embodiment, as shown in FIG. 4, when the first cold trap 23 is separated from the first freezing container 22 and the second cold trap 25 is separated from the second freezing container 24, the carbon dioxide in the second cold trap 25 is gasified and enters the isotope mass spectrometry analysis system 3 under the low flow rate carrier gas. The isotope mass spectrometry analysis system 3 includes a four-way valve 31 in communication with the second port of the second cold trap 25, and the second cold trap 25 is in communication with an isotope gas mass spectrometer 33 through the four-way valve 31. When performing mass spectrometry analysis, the second cold trap 25 is taken out of the freezing liquid, and the second cold trap 25 is heated at 150° C., so that carbon dioxide is completely released. Then, by the low flow rate carrier gas, the re-gasified carbon dioxide is introduced into the four-way valve 31 through the fifth connecting pipe 217, and then is introduced into an interface device 32 through the four-way valve 31 after passing through the sixth connecting pipe 34, and then the carbon dioxide is introduced into the isotope gas mass spectrometer 33 through the interface device 32 to facilitate isotope mass spectrometry analysis.

In an embodiment, the isotope gas mass spectrometer 33 is in communication with the second port of the chemical trap 13 through a four-way valve 31. In order to improve the practicability of this device, a bypass pipe 4 provided in this embodiment connects the chemical trap 13 with the four-way valve 31, and then the mixed gas is introduced into the interface device 32 through the seventh connecting pipe 35, so that the conventional carbon element detection may be realized.

A method for the Nano-C isotope analysis includes:

The weighed sample is put into the vacuum sample injector 14, and the sample in the vacuum sample injector 14 is alternately vacuumized and purged with helium, and the duration of each of vacuumizing and purging with helium is 30 seconds. After 5-10 times of alternating treatment, the interference of carbon in the air on the sample may be basically removed.

The treated sample falls into the reaction tube 12 of the element analyzer 11, and high-purity oxygen is introduced. At this time, the carrier gas is in a high flow rate mode of 40-100 ml/min carbon element. The setting of reaction duration and temperature needs to be calibrated by using nanomolar isotope reference materials to determine the appropriate reaction conditions and ensure that the carbon elements in the sample are completely converted into carbon dioxide. If the sample contains two different types of carbon, carbonate carbon and non-carbonate carbon, the optimal reaction temperature and duration of different types of carbon may be determined by using nanomolar isotope reference materials to ensure that the two different types of carbon may be converted into carbon dioxide step by step, so as to achieve the purpose of distinction.

While the carbon in the reaction tube 12 is undergoing oxidative combustion, the six-way valve 21 is set as shown in FIG. 2, and the first cold trap 23 is lowered into liquid nitrogen to freeze the carbon dioxide generated by the reaction under −196° C. At this time, the carrier gas is helium with a high flow rate. When the reaction is completed and the first cold trap 23 is frozen, the first cold trap 23 is lifted, and the six-way valve 21 is set to the state shown in FIG. 3. At the same time, the second cold trap 25 is lowered into liquid nitrogen, and enough time is set to completely freeze the carbon dioxide frozen in the first cold trap 23 into the second cold trap 25. At this time, the carrier gas is helium with a low flow rate of 2-10 ml/min. After freezing, the second cold trap 25 is lifted and heated to 150° C., so as to ensure the complete release of frozen carbon dioxide.

In the state of FIG. 4, under the helium carrier gas mode of low flow rate of 2-10 ml/min carbon element, the carbon dioxide sample gas released from the second cold trap 25 is completely introduced into the isotope gas mass spectrometer 33 for carbon isotope analysis. The specific example is as follows.

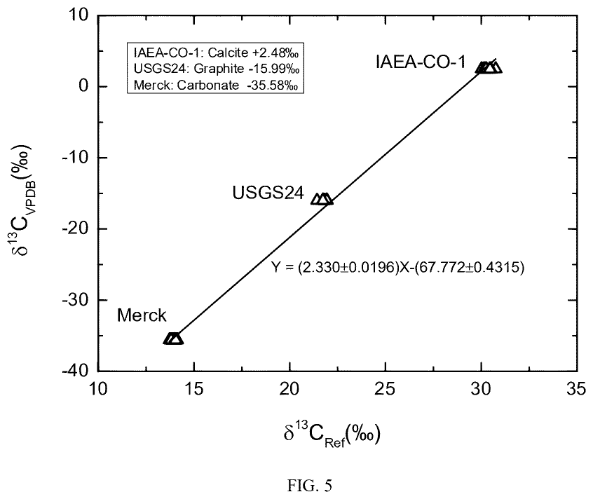

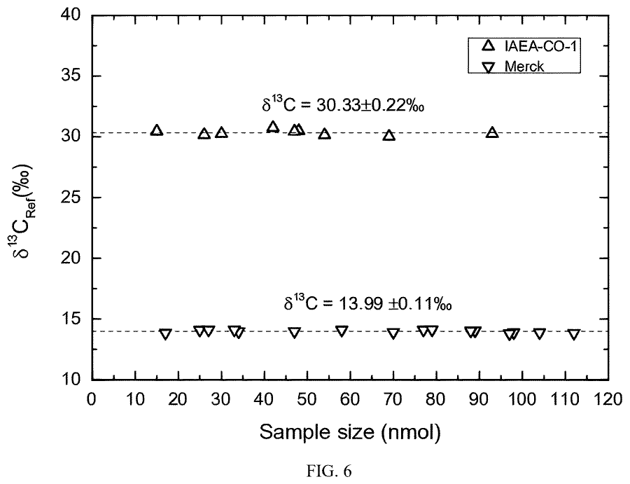

Three international reference materials of carbon isotopes are selected to verify the method according to the present disclosure, namely IAEA-CO-1 carbonate, with δ¹³C=2.48‰, USGS24 graphite, with δ¹³C =−15.99‰ and Merck carbonate, with δ¹³C =−35.58‰. As shown in FIG. 5, when the carbon isotope composition is from −40‰ to +10‰, the linearity of the analysis results is very good. As shown in FIG. 6, when the sample weight of carbonate is 10 to 120 nmol, the accuracy of carbon isotope analysis is ±0.11‰ to ±0.22‰, which has a good analytical accuracy. Therefore, the present disclosure solves the technical bottleneck of “trace” of carbon isotope analysis, and successfully realizes the accurate determination of nanomolar carbon isotope.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

What is claimed is:

1. A Nano-C isotope analysis device, comprising: an element analysis system, a carbon dioxide freezing enrichment system and an isotope mass spectrometry analysis system connected in sequence;
wherein the carbon dioxide freezing enrichment system comprises a six-way valve connected to the element analysis system, the six-way valve is in communication with a first freezing assembly and a second freezing assembly independently arranged, and one end of the second freezing assembly is in communication with the isotope mass spectrometry analysis system;
wherein the first freezing assembly comprises a first freezing container containing a freezing liquid, and a first cold trap in communication with the six-way valve is arranged and capable of being lifted and lowered in the first freezing container; and
the second freezing assembly comprises a second freezing container containing a freezing liquid, and a second cold trap in communication with the six-way valve is arranged and capable of being lifted and lowered in the second freezing container.

2. The Nano-C isotope analysis device according to claim 1, wherein the element analysis system comprises an element analyzer, a reaction tube is arranged in the element analyzer for converting carbon elements in raw materials to be detected into gaseous carbon dioxide, one port of the reaction tube is in communication with the six-way valve through a ventilation pipeline, and a first gas supply device is arranged on the ventilation pipeline for supplying high-speed carrier gas.

3. The Nano-C isotope analysis device according to claim 2, wherein a chemical trap is arranged on the ventilation pipeline, and the chemical trap is arranged between the element analyzer and the six-way valve, a first port of the chemical trap is in communication with the port of the reaction tube, and a second port of the chemical trap is in communication with the six-way valve.

4. The Nano-C isotope analysis device according to claim 2, wherein the ventilation pipeline is provided with two branch pipes independently arranged, and the two branch pipes are respectively provided with a first valve and a second valve, the first valve is in communication with an exhausting device for evacuating carrier gas, and the second valve is in communication with a second gas supply device for supplying auxiliary carrier gas.

5. The Nano-C isotope analysis device according to claim 3, wherein when the first cold trap is located below a freezing liquid level in the first freezing container to freeze carbon dioxide gas for a first time, the second cold trap is separated from the second freezing container, the ventilation pipeline is in communication with a first port of the first cold trap through the six-way valve, and a second port of the first cold trap is in communication with an evacuation pipe arranged on the six-way valve through the six-way valve.

6. The Nano-C isotope analysis device according to claim 5, wherein when the first cold trap is located in the first freezing container to freeze the carbon dioxide gas for the first time, a first port of the second cold trap is in communication with a third gas supply device through the six-way valve, and a second port of the second cold trap is in communication with the isotope mass spectrometry analysis system.

7. The Nano-C isotope analysis device according to claim 6, wherein when the second cold trap is below a freezing liquid level in the second freezing container to freeze the carbon dioxide gas for a second time, the first cold trap is separated from the first freezing container to ensure carbon dioxide frozen and enriched in the first cold trap to be completely frozen and enriched in the second cold trap, and the ventilation pipeline is in communication with the evacuation pipe through the six-way valve; and the third gas supply device is in communication with the second port of the first cold trap through the six-way valve, and the first port of the first cold trap is in communication with the first port of the second cold trap through the six-way valve.

8. The Nano-C isotope analysis device according to claim 7, wherein when the first cold trap is separated from the first freezing container and the second cold trap is separated from the second freezing container, carbon dioxide frozen and enriched in the second cold trap is gasified, and low-speed carrier gas provided by the third gas supply device enters the isotope mass spectrometry analysis system.

9. The Nano-C isotope analysis device according to claim 8, wherein the isotope mass spectrometry analysis system comprises a four-way valve in communication with the second port of the second cold trap, and the second cold trap is in communication with an isotope gas mass spectrometer through the four-way valve.

10. The Nano-C isotope analysis device according to claim 9, wherein the isotope gas mass spectrometer is in communication with the second port of the chemical trap through the four-way valve and directly connected to the element analyzer to realize constant analysis.
